(19) United States
(12) Patent Application Publication
(10) Pub. No.: US 2004/0049304 A1
(43) Pub. Date: Mar. 11, 2004

(54) Method and apparatus for digital signal communication between equalizer and surround sound systems

(76) Inventor: Heng-Chien Chen, Taipei (TW)

Correspondence Address: Alan D. Kamrath, Rider, Bennett, Egan & Arundel, LLP, Suite 2000, 333 South Seventh Street, Minneapolis, MN, 55402, US

(21) Appl. No.: 10/237,443

(22) Filed: Sep. 9, 2002

(51) Int. Cl. G06F 17/00

(52) U.S. Cl. 700/94

(57) ABSTRACT

A method and apparatus for digital signal communication between equalizer and surround sound systems is disclosed. The method involves converting analog audio signals output on multiple audio channels from the front-end equalizer to digital voice packets, passing them onto a signal transmission medium, and restoring the received digital voice packets back to the original analog audio signals by the rear-end broadcasting equipment. The signal transmission medium is connected to multiple speakers, such that digital voice packets received by each speaker respective to a particular audio channel are restored by a D/A converter to analog audio signals and then amplified. The restored analog audio signals are then output through a speaker connected by the signal transmission medium. Such signal transmission means may avoid the usual high RLC value on the transmissio n line related with conventional audio cables causing power attenuation and degradation of sound reproduction.

### BACKGROUND OF THE INVENTION

1. Field of the Invention

The present invention relates to a method and apparatus for digital signal communication between equalizer and surround sound systems, especially to a method of transmitting audio signals that can improve the quality of sound considerably after the recording, mixing, and pre-amplification stages, and can avoid possible degradation of sound due to power attenuation in the audio transmission media.

2. Description of Related Arts

The setting up of the speakers around the performance stage and the wiring of audio cables to the power amplifiers are the key factors affecting the quality of sound reproduction in a live performance. For surround sound effects, the audio equipment set up includes microphones, mixers, equalizers, power amplifiers, and speakers. The stereo and surround sound speakers have to be set up surrounding the performance stage. For a small-scale performance, the stage set up probably has to use twenty or so speakers. Normally high-powered audio cables are used to connect the speakers and power amplifiers, such that each speaker (60) is connected to a corresponding power amplifier (50) using multiple segments of high-powered audio cable (70) for the whole equipment setup. Considering all the speakers and amplifiers necessary for a performance stage, the wiring is a complicated task, and the length of high-powered audio cable required would also be monstrous. The material costs plus the labor for such a stage set up are usually a significant burden on the cost effectiveness of staging a concert.

But in recent years, high quality audio equipment has been produced in more compact sizes, and consumers can easily purchase them on an economical budget. Their applications are no longer limited to stage performances or recording industries. As an example, many audio equipment stores are actively promoting home theater systems equipped with quadraphonic speakers. Such speaker system usually includes four sets of right channel and left channel speakers, one mid range speaker, and one woofer.

To create the same stereo and surround sound effect as in a live performance, the broadcasting equipment in the front-end has to be linked with multiple loudspeakers in the rear-end. The cable wiring between all the speakers and amplifiers would mean considerable costs besides the costs of the sound reproduction equipment. Furthermore, the horrible mass of cables on the ground may trip people passing through the equipment setup area, and for home theaters these may spoil the interior design of a home setting.

### SUMMARY OF THE INVENTION

The main object of the present invention is to provide a method and apparatus for digital signal communication between an equalizer and surround sound system using regular computer networking cables instead of high-powered audio cables, applicable for a large-scale performance stage as well as home theaters, with the high quality sound being retained in sound reproduction.

The method for digital signal communication involves converting the analog audio signals over multiple audio channels to digital voice packets for transmission over a bus-type signal transmission medium to the broadcasting and amplification equipment in the rear-end, restoring the packet contents to the original analog audio signals, and then amplifying and outputting the original sound over the speaker system. Even though regular networking cables are used instead of conventional audio cables to transmit audio signals between the equalizer and the surround sound system, the original high quality sound is retained after the audio signal conversion, transmission and amplification processes.

The secondary objective of the invention is to provide a digital communication interface for fast setting up of the sound reproduction equipment to produce stereo and surround sound effects, which comprises a digital audio transmission device, at least one set of digital audio signal reception devices, and a bus-type signal transmission medium.

The output of continuous analog signals over multiple audio channels are received by the above mentioned digital audio transmission device, and converted to digital voice packets respective to a particular audio channel. The digital voice packets are transmitted over the signal transmission medium to the rear-end equipment, where the packets are restored to the original analog audio signals, and then passed through the power amplifier before eventually outputting over the speaker system. According to the present invention, the proposed scheme of audio transmission over the networking cables may avoid substantial expenditure for acquiring conventional audio cables and the problems of power attenuation over the conventional audio cables.

The features and structure of the present invention will be more clearly understood when taken in conjunction with the accompanying figures.

### BRIEF DESCRIPTION OF THE DRAWINGS

FIG. 1 is the block architecture of the present invention;

FIG. 2 is block diagram of the first part of the implementation hardware for the invention;

FIG. 3 is block diagram of the second part of the implementation hardware for the invention;

FIG. 4 is a proposed setup of the surround sound equipment according to the invention;

FIG. 5 is the conventional setup for audio equipment and speakers.

### DETAILED DESCRIPTION OF THE PREFERRED EMBODIMENT

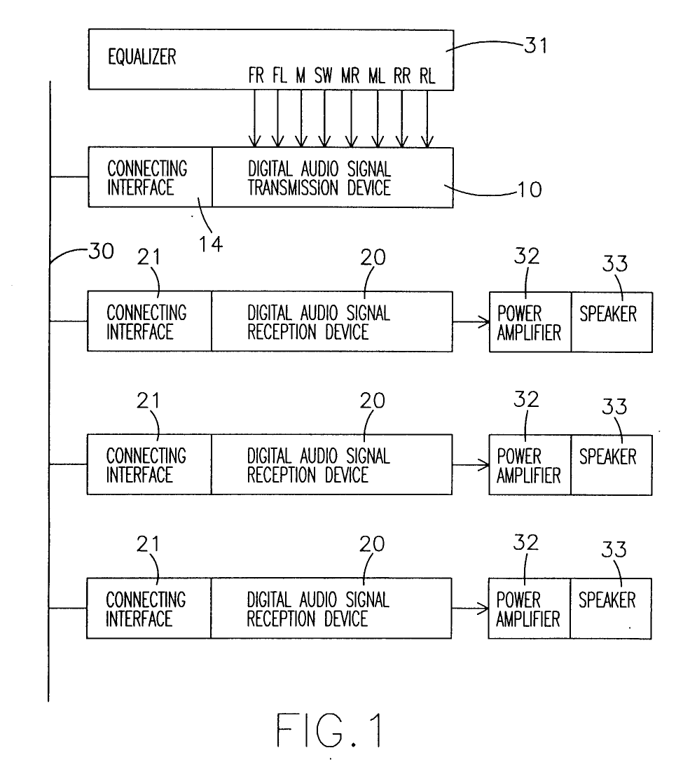

With reference to FIG. 1, the method for digital signal communication between the equalizer and surround sound systems having multiple speakers and amplifiers comprises the steps of:

converting original analog audio signals over multiple audio channels output of the equalizer to the digital format;

coding digital audio signals respective to a particular audio channel and generating voice packets before sending to a remote broadcasting device through a signal transmission medium;

retrieving and decoding the digital voice packets by the broadcasting device after receiving the packets corresponding to the respective audio channel;

decoding and restoring the audio signals to the analog format to be broadcasted over a speaker after power amplification.

Data compression and decompression can be optionally included in the above signal transmission process which may solve the problem of transmission bandwidth on certain signal transmission media.

The present invention is to be applied on the intermediate stage audio signal amplification and transmission interface, disposed in between the front-end sound recording and mixing devices and rear-end broadcasting devices, capable of replacing all conventional audio connecting cables and cutting down the wiring costs considerably, especially for sound broadcasting over long distances.

With reference to FIG. 1, the architecture in accordance with the present invention comprises:

a digital audio transmission device (10) being connected to multiple channel outputs from the equalizer (31), e.g. FR, FL, M, RR, RL, SW, MR, AND ML or etc.;

at least one digital audio signal reception device (20) being connected to the corresponding power amplifier (32) which in turn is connected to a corresponding speaker(33);

a bus-type signal transmission medium (30) being connected to the respective connecting interface for connecting to the front-end digital audio transmission device (10) and the rear-end digital audio signal reception device (20).

In actual operation, the analog audio signals over multiple audio channels output of the equalizer (31) are converted by the digital audio transmission device (10) to digital voice packets before passing on to the signal transmission medium (30); and the voice packets are retrieved by the rear-end digital audio signal reception device (20) respective to a particular audio channel; and then the decoded audio signals are passed through a power amplifier (32) to be output over respective speaker (33).

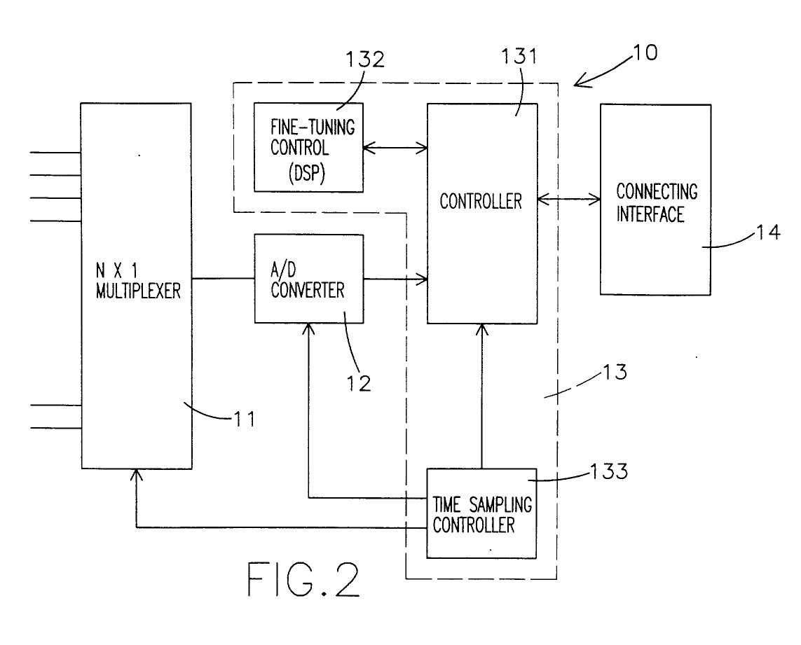

With reference to FIG. 2, the digital audio transmission device (10) comprises a front-end control unit (13), a multiplexer (11), and a connecting interface (14).

The front-end control unit (13) for converting audio signals to digital voice packets possibly further includes a data compression process. The control unit (13) comprises:

a controller (131) which may be a CPU with arithmetic processing capabilities, whose output terminal is to control the analog signal sampling of a A/D converter (12) through a fine-tuning control (132), a digital signal processor; and

a time-sampling control (133) being connected between the controller (131), a A/D converter (12) and a multiplexer (11) for providing the necessary clock signals to synchronize the operation;

a multiplexer (11) which has multiple input terminals connected to corresponding channel outputs of the equalizer (not identified in the diagram), and whose output terminal is connected to the front-end control unit (13) through the A/D converter for passing on the digital signals; and

a connecting interface (14) being installed on the output terminal of the front-end control unit (13) for connecting to the bus-type signal transmission medium (not identified in the diagram).

In actual operation, continuous audio signals are sampled from multiple audio channels by the digital audio transmission device (10) through the multiplexer (11); and the analog audio signals are passed to the A/D converter (12) and converted to the required digital signal format, which are then sent to the controller (131) for coding and adding data compression to be transmitted to the broadcasting end through the signal transmission medium (not identified in the diagram) and the connecting interface (14).

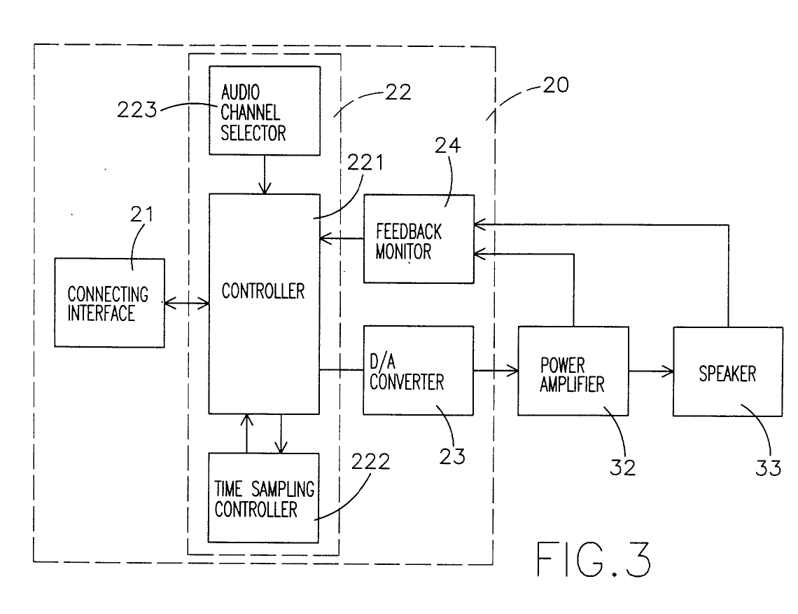

With reference to FIG. 3, the block diagram shows the rear-end digital audio signal reception device (20) comprises a rear-end control unit (22), a D/A converter (23), a feedback monitor (24) and a connecting interface (21); wherein:

the rear-end control unit (22) for converting the audio signals to voice packets and further data compression and coding, comprises:

a controller (221) having the output terminal connected to a D/A converter (23) through a time-sampling control (222) may be a microprocessor with arithmetic processing capabilities; and

an audio selector (223) being connected to the input terminal of the controller (221) for setting the audio channel received by the controller (221) may be implemented by press key, rotation control knob, DIP switch or software setting for manually controlling the audio channel reception;

a feedback monitor (24) being installed in between the input terminal of the controller (221) and the output of the power amplifier (32) and the speaker (33) for returning the amplified signal output back to the controller (221);

a D/A converter (23) being installed on the output terminal of the rear-end control unit (22) for decoding and decompressing the digital audio signals received and restoring to the analog audio signals to be passed on to the power amplifier (32); and

a connecting interface (21) being attached to the output terminal of the rear-end control unit (22) for connecting to the bus-type signal transmission medium (not shown in the diagram).

In actual operation, digital voice packets on the respective audio channel are set up by the rear-end control unit (22) through the audio channel selector (223), thus allowing the controller (221) of the audio signal reception device (20) to retrieve the voice packets on the corresponding audio channel from the signal transmission medium through the connecting interface (21). The voice packets are then decoded and decompressed to produce the analog audio signals, and passed through the power amplifier (23) to be output over the speaker (33).

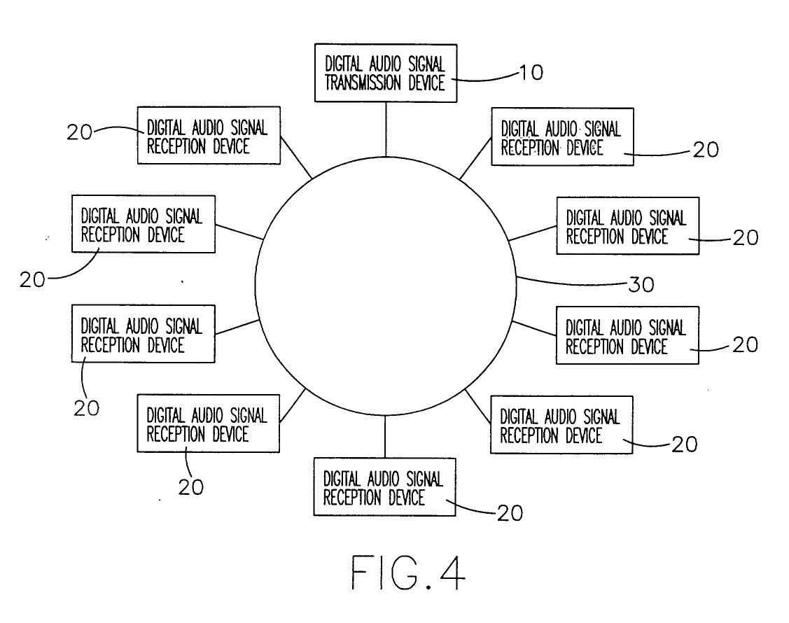

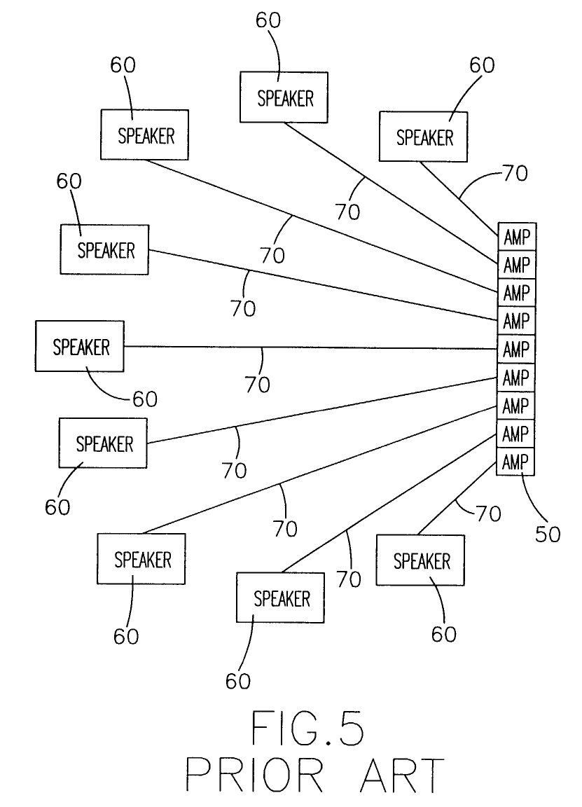

FIG. 4 is a proposed set up for the sound reproduction equipment in accordance with the present invention, in which the respective digital audio signal reception devices (20) are strategically placed around the performance stage, and linked with the digital audio transmission device (10) through the signal transmission medium (30). The use of signal transmission medium in accordance with the present invention can replace the conventional high-powered audio signal cables, as compared with the conventional equipment setup shown in FIG. 5. In the conventional scheme, since each speaker is connected to the respective amplifier by a separate conventional high-powered audio cable, thus multiple segments of the conventional audio cable are required for the audio equipment setup. But in the present invention, one signal transmission medium interconnects all the digital audio signal reception devices (20) in tandem arrangement, which is advantageous in many ways:

Reliable signal transmission: using a single networking cable to connect the front-end and back end audio equipment in series over which digitized voice packets are transmitted;

Light sized audio equipment and simplified setup procedures: replacing the high-powered analog audio transmission media with simple cable connections;

High quality sound reproduction: eliminating possible degradation in sound reproduction due to power attenuation; and

Low cost: using networking cable and fewer cables than in the prior art.

The foregoing description of the preferred embodiments of the present invention is intended to be illustrative only and, under no circumstances, should the scope of the present invention be so restricted.

What is claimed is:

1. A method for digital signal communication between equalizer and surround sound systems comprises:
converting analog audio signals over multiple channels output of an equalizer to digital voice packets,
sending digital voice packets to a remote broadcasting device through a signal transmission medium,
retrieving digital voice packets respective to a particular audio channel from the signal transmission medium, and
restoring to the original analog audio signals to be output over a broadcasting device after power amplification.

2. The method for digital signal communication between equalizer and surround sound systems as claimed in claim 1, wherein the process of converting analog audio signals to digital voice packets includes the steps of:
conversion of analog audio signals to digital format to be transmitted over the signal transmission medium; and
coding of digital voice packets in accordance with a specific digital coding mechanism.

3. The method for digital signal communication between equalizer and surround sound systems as claimed in claim 2, wherein the digital signal processing includes the steps of:
decoding of digital voice packets after retrieving the voice packets from the signal transmission medium respective to a particular audio channel; and
converting the decoded digital audio signals to the original analog audio signals respective to a particular audio channel.

4. The method for digital signal communication between equalizer and surround sound systems as claimed in claim 3, wherein the process of coding digital audio signal packets may further include data compression, thus the digital audio signal packets have to be decompressed in decoding process to restore to the analog audio signals.

5. The method for digital signal communication between equalizer and surround sound systems as claimed in claim 1, wherein the signal transmission medium is a bus-type networking cable.

6. The method for digital signal communication between equalizer and surround sound systems as claimed in claim 2, wherein the signal transmission medium is a bus-type networking cable.

7. The method for digital signal communication between equalizer and surround sound systems as claimed in claim 3, wherein the signal transmission medium is a bus-type networking cable.

8. The method for digital signal communication between equalizer and surround sound systems as claimed in claim 4, wherein the signal transmission medium is a bus-type networking cable.

9. An apparatus for digital signal communication between equalizer and surround sound systems, comprising:
a digital audio transmission device, being connected to multiple channels outputs of an equalizer;
at least one digital audio signal reception device being connected to the corresponding power amplifier and in turn to a speaker; and
a signal transmission medium for connecting the front-end digital audio transmission device and all rear-end digital audio signal reception devices.

10. The apparatus for digital signal communication between equalizer and surround sound systems as claimed in 9, wherein the front-end digital audio transmission device includes:
a front-end control unit used for processing digital voice packets, in which data compression mechanism may be included;
a multiplexer has multiple input terminals corresponding to multiple channel outputs of the equalizer and an output terminal is connected to the front-end control unit for passing on the digital signals; and
a connecting interface being coupled onto the output terminal of the control unit for connecting to the bus-type signal transmission medium.

11. The apparatus for digital signal communication between equalizer and surround sound systems as claimed in 10, wherein the front-end control unit of the digital audio transmission device includes:
a controller whose output controls the signal sampling value of an A/D converter by means of a fine-tuning control;
a time sampling control being connected in between the controller, an A/D converter, and a multiplexer for providing clock pulse to synchronize the operation; and
a multiplexer which has multiple input terminals connected to corresponding channel outputs of the equalizer, and whose output terminal is connected to the front-end control unit through the A/D converter for passing on the digital signals; and

12. The apparatus for digital signal communication between equalizer and surround sound systems as claimed in 9, wherein the rear-end digital audio signal reception device comprises:
a rear-end control unit for processing the voice packets, in which data decompression may be included;
a D/A converter being installed on the output of the control unit for decoding the received packets and restoring to the original analog signal format, in which decompression may be included; and
a connecting interface being coupled to the output of the rear-end control unit for connecting the signal transmission medium.

13. The apparatus for digital signal communication between equalizer and surround sound systems as claimed in 11, wherein the rear-end digital audio signal reception device comprises:
a rear-end control unit for processing the voice packets, in which data decompression may be included;
a D/A converter being installed on the output of the control unit for decoding the received packets and restoring to the original analog signal format, in which decompression may be included; and
a connecting interface being coupled to the output of the rear-end control unit for connecting the signal transmission medium.

14. The apparatus for digital signal communication between equalizer and surround sound systems as claimed in 12, wherein the rear-end control unit of the digital audio signal reception device comprises:
a controller whose output being connected through a time-sampling control to the D/A converter,
an audio channel selector being coupled onto the input terminal of the controller for setting up the audio channel for signal reception by the controller with manual control; and
a feedback monitor being installed in between the input terminal of the controller and the output of the power amplifier and the speaker for returning the amplified output signals back to the controller.

15. The apparatus for digital signal communication between equalizer and surround sound systems as claimed in 13, wherein the rear-end control unit of the digital audio signal reception device comprises:
a controller whose output being connected through a time-sampling control to the D/A converter,
an audio selector being coupled onto the input terminal of the controller for setting up the audio channel for signal reception by the controller with manual control; and
a feedback monitor being installed in between the input terminal of the controller and the output of the power amplifier and the speaker for returning the amplified output signals back to the controller.

16. The apparatus for digital signal communication between equalizer and surround sound systems as claimed in claim 9, wherein the signal transmission medium is a bus-type networking cable.

17. The apparatus for digital signal communication between equalizer and surround sound systems as claimed in claim 12, wherein the signal transmission medium is a bus-type networking cable.

18. The apparatus for digital signal communication between equalizer and surround sound systems as claimed in claim 13, wherein the signal transmission medium is a bus-type networking cable.

19. The apparatus for digital signal communication between equalizer and surround sound systems as claimed in claim 11, wherein the audio channel selector is selected from a group consisting of a press key, a rotation knob, a DIP switch and a software setting.

20. The apparatus for digital signal communication between equalizer and surround sound systems as claimed in claim 14, wherein the audio channel selector is selected from a group consisting of a press key, a rotation knob, a DIP switch and a software setting.
